(19) United States
(12) Patent Application Publication
(10) Pub. No.: US 2017/0264117 A1
(43) Pub. Date: Sep. 14, 2017

(54) HOUSING WITH MULTIPLE MOBILE ELECTRONIC DEVICE CHARGING STATIONS AND A DISPLAY

(71) Applicant: Constellation Marketing Services, Inc., Chicago, IL (US)

(72) Inventors: Barry Deutsch, Woodinville, WA (US); Alan Dillingham, Woodinville, WA (US)

(21) Appl. No.: 15/065,041

(22) Filed: Mar. 9, 2016

(51) Int. Cl. H02J 7/00; B65D 25/54; B65D 51/24; G09F 13/00; F21V 23/04; G09F 23/00; G09F 23/06; B65D 43/16; F21V 33/00

(52) U.S. Cl. CPC H02J 7/0044; B65D 43/166; B65D 25/54; B65D 51/248; F21V 33/0004; F21V 23/04; H02J 7/0027; G09F 23/00; G09F 23/06; G09F 13/00; F21Y 2115/10

(57) ABSTRACT

A housing including a body, a lid, a plurality of light sources, and a power source. The body includes a top opening, a base, and at least one side wall. The top opening, the base, and the at least one side wall all define a cavity therebetween. The lid is pivotably coupled to the body and movable from a closed state covering the top opening to an open state. The lid includes a translucent screen that is positioned on an underside of the lid. The plurality of light sources are disposed within the lid. The power source is electrically coupled to the plurality of light sources to provide electrical power thereto.

### BACKGROUND

The housing described herein includes a plurality of charging stations for mobile electronic devices and a display.

Mobile electronic devices, such as mobile phones, are widely used. In order to maintain proper power levels for the operation of a mobile electronic device, the battery of the mobile electronic device needs to be recharged from time to time. Often, at inopportune times, mobile electronic device users may be located at public locations and businesses, such as restaurants and bars, without the ability to recharge the mobile electronics device's battery. Those businesses often desire to advertise their products and services, and providing the public with access to charging stations creates an opportunity for the businesses to advertise. Thus, a device that provides both public charging stations as well as advertising opportunities is desirable.

### SUMMARY

In a first embodiment, a housing includes a body, a lid, a plurality of light sources, and a power source. The body includes a top opening, a base, and at least one side wall. The top opening, the base, and the at least one side wall all define a cavity therebetween. The lid is pivotably coupled to the body and movable from a closed state covering the top opening to an open state. The lid includes a translucent screen that is positioned on an underside of the lid. The plurality of light sources are disposed within the lid. The power source is electrically coupled to the plurality of light sources to provide electrical power thereto.

In another embodiment, the housing includes the features of the first embodiment without the translucent screen and the plurality of light sources in the lid. The body further includes a plurality of receptacles disposed within the base. The plurality of receptacles permit electrical coupling of a plurality of mobile electronic devices to the power source.

In another embodiment, the housing includes the features of the first embodiment as well as a plurality of receptacles disposed within the base.

Other aspects of the disclosure will become apparent by consideration of the detailed description and accompanying drawings.

### BRIEF DESCRIPTION OF THE DRAWINGS

FIG. 1 is a perspective view of a housing with multiple mobile electronic device charging stations, in accordance with one embodiment.

FIG. 2 is a side view of the housing in FIG. 1 in an open state.

FIG. 3 is a side view of the housing in FIG. 1 in a closed state.

FIG. 4 is a front side view of the housing in FIG. 1.

FIG. 5 is a front side view of the housing in FIG. 1.

FIG. 6 is a top view of the housing in FIG. 1.

FIG. 7 is a block diagram of an electronic circuit for the housing in FIG. 1.

FIG. 8 is a block diagram of an electronic circuit for the housing in FIG. 1.

FIG. 9 is a block diagram of an electronic circuit for the housing in FIG. 1.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

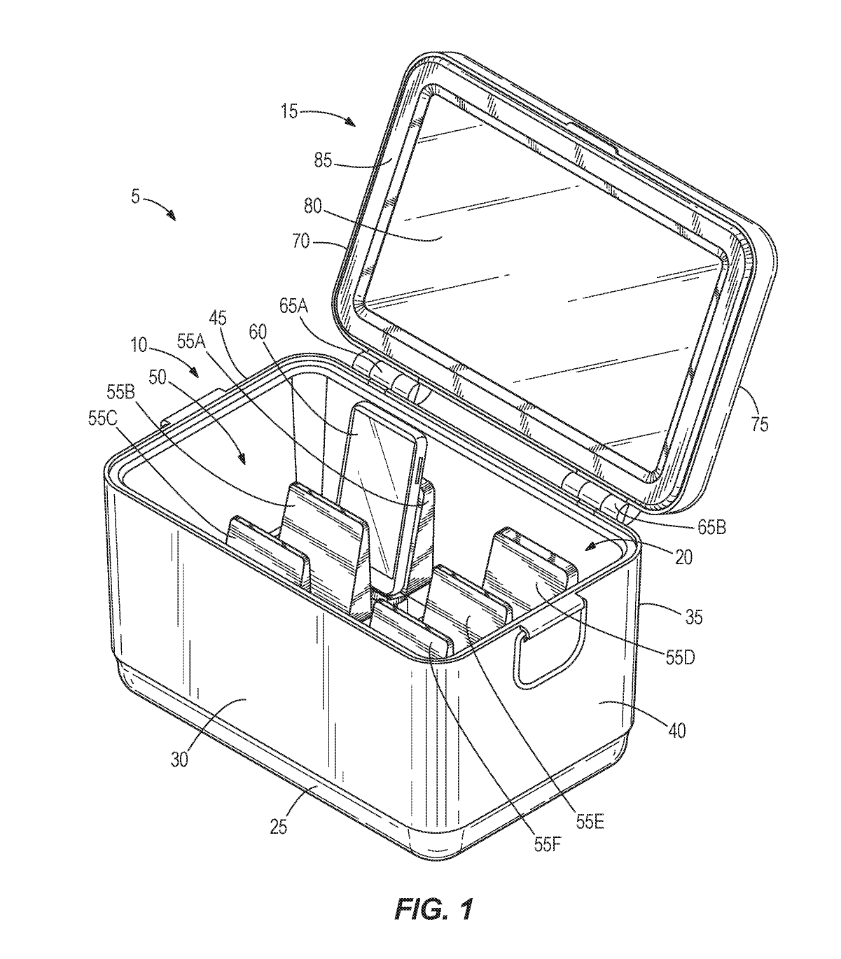

FIG. 1 illustrates an exemplary embodiment of a housing 5. The housing 5 includes, among other things, a body 10 and a lid 15. The body 10 is generally box-shaped to resemble a cooler, which is commonly found in places such as bars or taverns. The body 10 includes, among other things, a top opening 20, a base 25, a front 30, a back 35, a first side 40, and a second side 45. The second side 45 is opposite from the first side 40. The top opening 20, the base 25, the front 30, the back 35, the first side 40, and the second side 45 define a cavity 50. Alternatively, the housing 5 may have a generally cylindrical shape (not shown) defined by a top opening, base, and at least one side wall defining a cavity therebetween and coverable with a lid. Other configurations of the housing are also suitable so long as they define a cavity for multiple mobile electronic devices.

A plurality of stands 55A-55F for supporting mobile electronic devices 60 are disposed within the cavity 50. The plurality of stands 55A-55F are coupled to the base 25 and extend toward the top opening 20 of the body 10, but they could be coupled and oriented differently within the cavity 50.

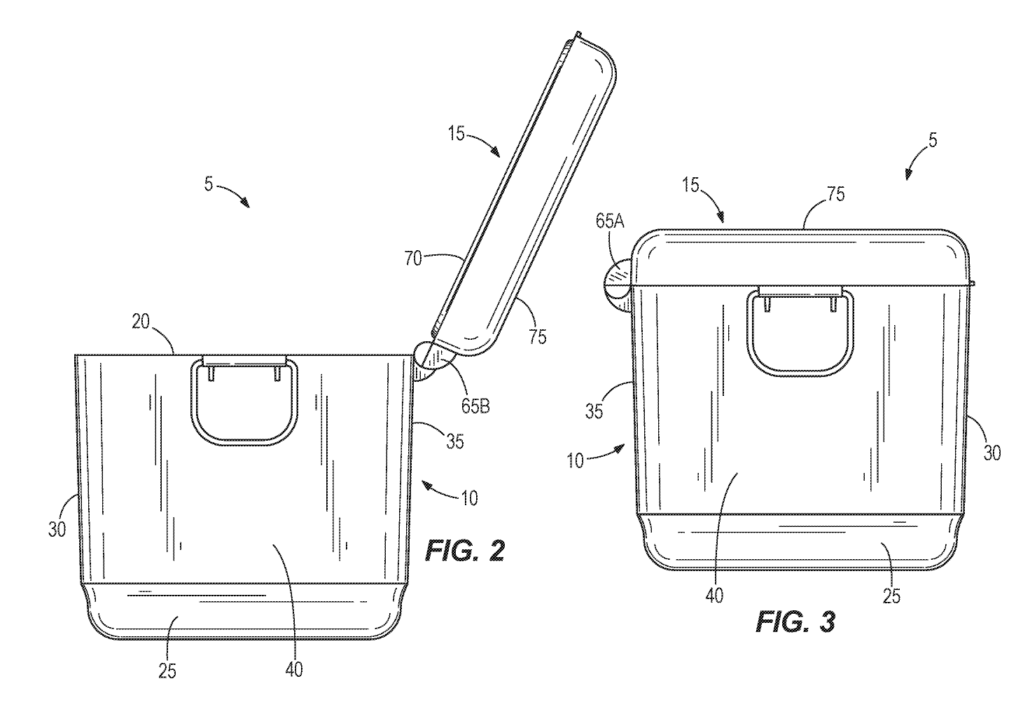

The lid 15 is pivotally coupled to the base 25 by a pair of hinges 65A, 65B. The lid 15 includes, among other things, an underside 70 and a topside 75. The underside 70 is opposite from the topside 75. The underside side 70 of the lid 15 includes, among other things, a translucent screen 80 and a border 85. The translucent screen 80 is composed of a material such as glass or plastic that allows visible light to pass through it. The lid 15 is movable from an open state (illustrated in FIG. 2) to a closed state (illustrated in FIG. 3).

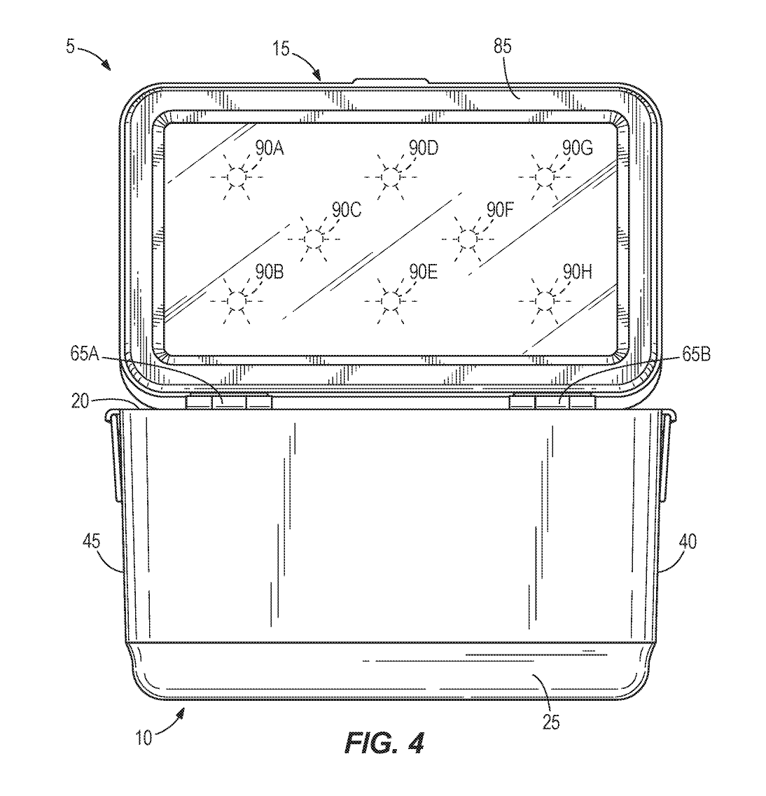

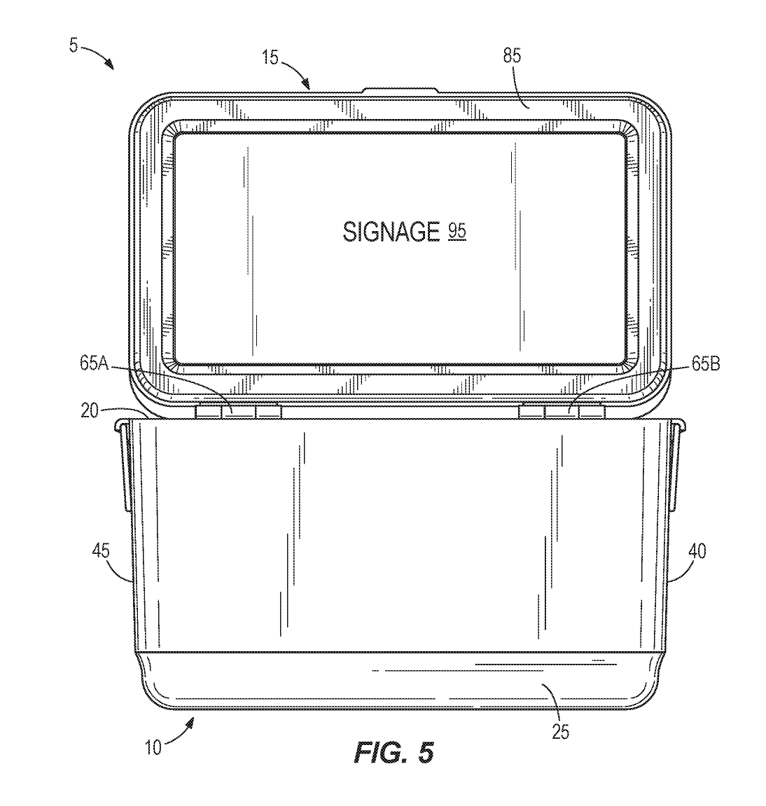

As illustrated in FIG. 4, a plurality of light sources 90A-90H are disposed within the lid 15 and between the topside 75 and the translucent screen 80. In some embodiments, the plurality of light sources 90A-90H include light-emitting diodes (LEDs). In other embodiments, the plurality of light sources 90A-90H include incandescent lights. As illustrated in FIG. 5, signage 95 may be coupled to the translucent screen 80. The signage 95 may include indicia, symbols, images, or any combination thereof. For example, the signage 95 may include an advertisement. The plurality of light sources 90A-90H are positioned within the lid 15 to illuminate the translucent screen 80 and the signage 95.

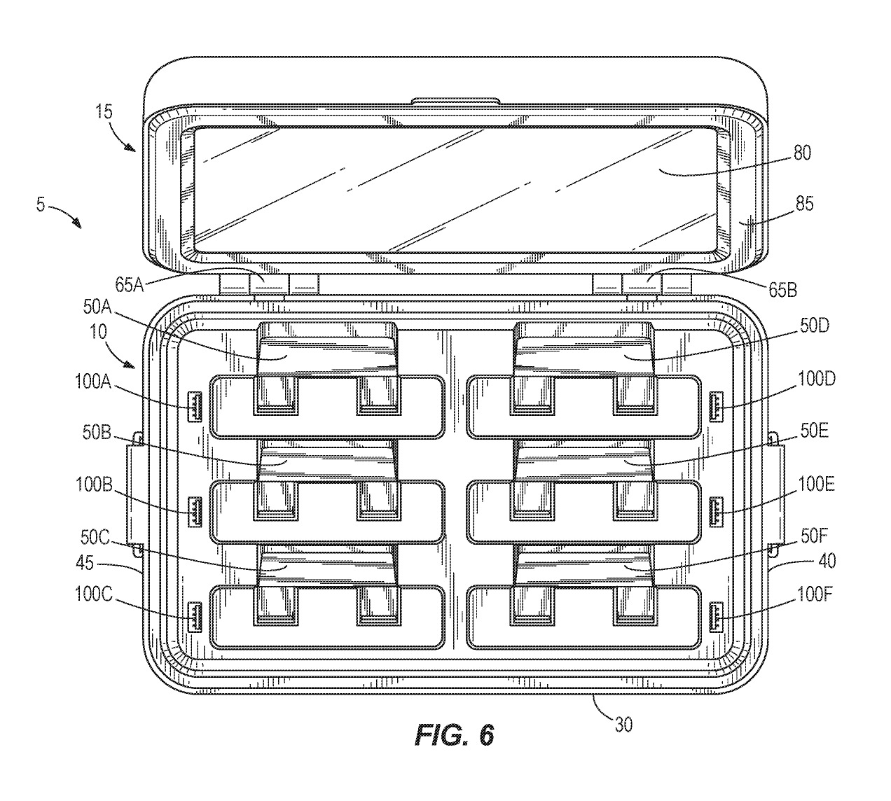

As illustrated in FIG. 6, a plurality of receptacles 100A-100F for receiving mobile electronic devices 60 (e.g., mobile phones) to be charged are disposed within the base 25. The plurality of receptacles 100A-100F may include USB (universal serial bus) connectors.

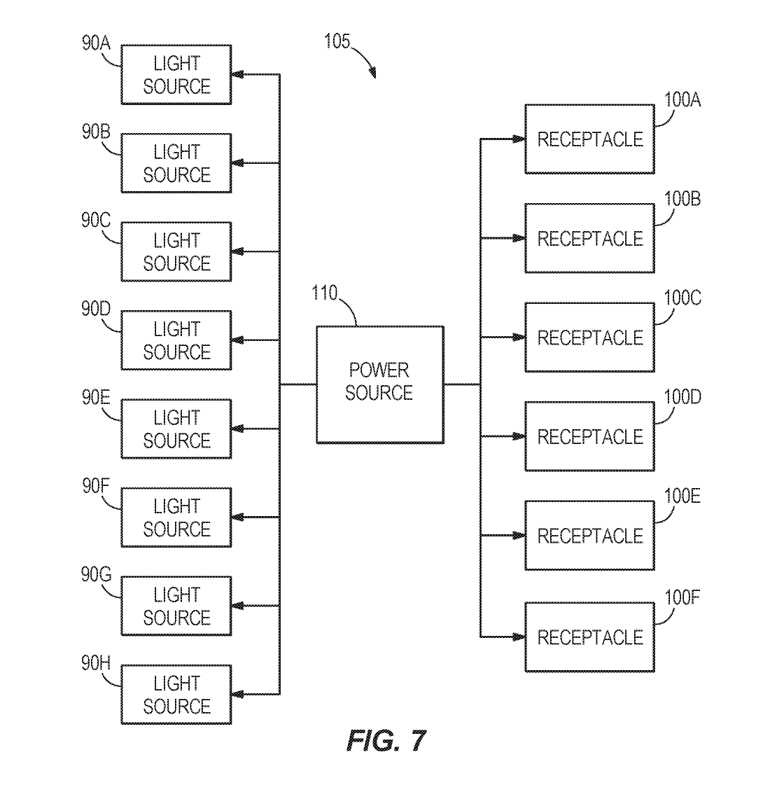

FIG. 7 illustrates an exemplary embodiment of an electronic circuit 105 for the housing 5. The electronic circuit 105 illustrated in FIG. 7 includes the plurality of light sources 90A-90H, the plurality of receptacles 100A-100F, and a power source 110. The plurality of light sources 90A-90H and the plurality of receptacles 100A-100F are electrically coupled to the power source 110. The power source 110 may be disposed within the base 25 of the body 10. The power source 110 may also be separate from the body 10.

The plurality of light sources 90A-90H may be electrically coupled to the power source 110 via one or more wires that run through the lengths of one or both of the hinges 65A, 65B. Running the wires through the lengths of the hinges 65A, 65B keeps the wires covered (e.g., out of sight) and prevents damage that may occur to the wires when the lid 15 is moved (e.g., between the open state and the closed state).

The power source 110 supplies a nominal DC voltage (e.g., 5 volts) to the plurality of light sources 90A-90G and the plurality of receptacles 100A-100F. The power source 110 may be powered by mains power having nominal line voltages between, for example, 100V and 240V AC and frequencies of approximately 50-60 Hz. The power source 110 may also supply lower voltages to operate circuits and components within the housing 5. The power source 100 may include an external power cord that plugs into a power receptacle disposed on or within the housing 5 (e.g., on the back 35 of the body 10). Alternatively, the power source 110 may include one or more batteries or battery packs.

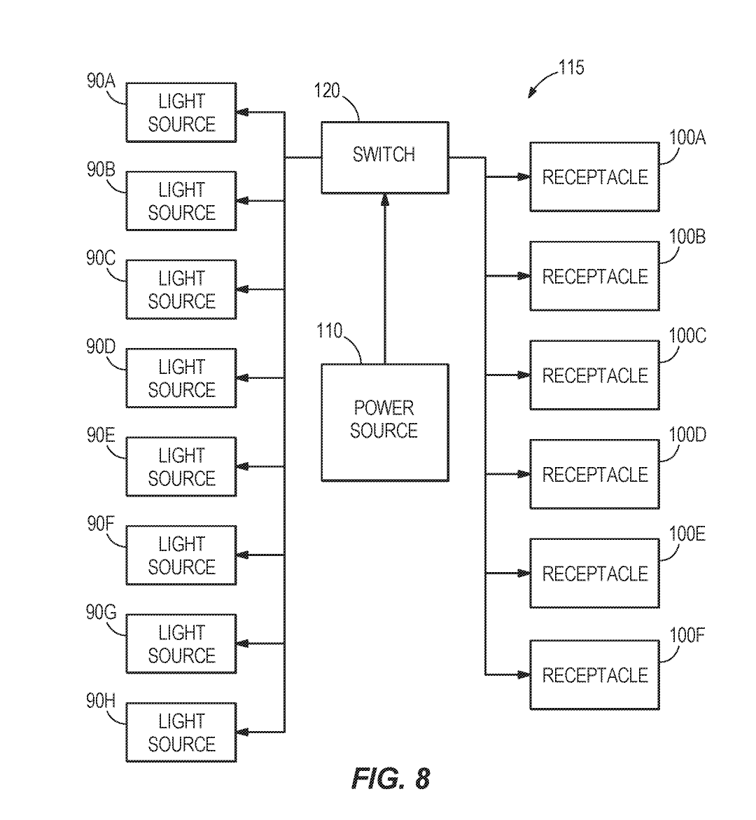

FIG. 8 illustrates another exemplary embodiment of an electronic circuit 115 for the housing 5. The electronic circuit 115 illustrated in FIG. 8 includes the plurality of light sources 90A-90H, the plurality of receptacles 100A-100F, the power source 110, and a switch 120. The plurality of light sources 90A-90G and the plurality of receptacles 100A-100F are electrically coupled to the power source 110 via the switch 120. The switch 120 selectively couples the plurality of light sources 90A-90H and the plurality of receptacles 100A-100F to the power source 110. The switch 120 may include any type of two-state (i.e., ON-OFF) switch, for example, a toggle switch, a pushbutton switch, and a selector switch. The switch 120 may be positioned on the back 35 of the body 10.

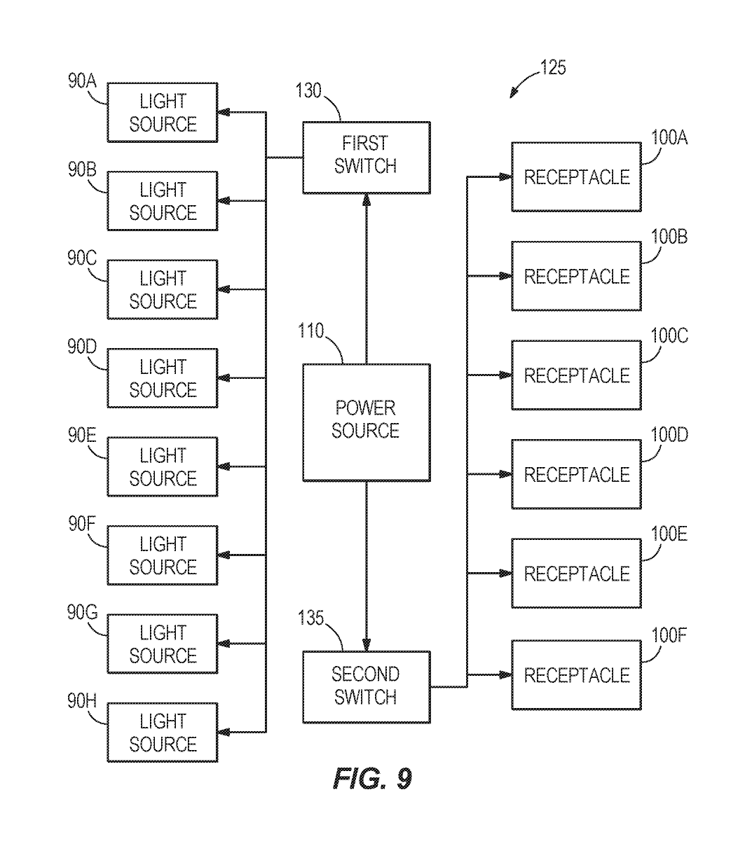

FIG. 9 illustrates another exemplary embodiment of an electronic circuit 125 for the housing 5. The electronic circuit 125 illustrated in FIG. 9 includes the plurality of light sources 90A-90H, the plurality of receptacles 100A-100F, the power source 110, a first switch 130, and a second switch 135. The plurality of light sources 90A-90H are electrically coupled to the power source 110 via the first switch 130. The first switch 130 selectively couples the plurality of light sources 90A-90H to the power source 110. The plurality of receptacles 100A-100F are electrically coupled to the power source 110 via the second switch 135. The second switch 135 selectively couples the plurality of receptacles 100A-100F to the power source 110. The first and second switches 130, 135 may include any type of two-state (i.e., ON-OFF) switches, for example, toggle switches, pushbutton switches, selector switches, and any combination thereof. The first and second switches 130, 135 may be positioned on the back 35 of the body 10.

Various features and advantages of the housing are set forth in the following claims.

What is claimed is:

1. A housing comprising:
a body, the body having a top opening, a base, and at least one side wall all defining a cavity therebetween;
a lid pivotably coupled to the body, the lid movable from a closed state covering the top opening to an open state, the lid including a translucent screen positioned on an underside of the lid;
a plurality of light sources disposed within the lid; and
a power source electrically coupled to the plurality of light sources to provide electrical power thereto.

2. The housing according to claim 1, wherein the plurality of light sources includes a plurality of light-emitting diodes.

3. The housing according to claim 1, wherein the lid further includes a top side opposite the underside, wherein the plurality of light sources are positioned between the underside and the top side.

4. The housing according to claim 1, wherein the lid further includes a border positioned on the underside of the lid and around the translucent screen.

5. The housing according to claim 1, wherein the body is generally rectangular shaped, wherein the at least one side wall is a first side, wherein the body further has a front, a back, and a second side.

6. The housing according to claim 1, wherein the underside of the lid is positioned adjacent to the top opening of the body when the lid is in the closed state.

7. The housing according to claim 1, wherein the lid pivotably is coupled to the body via at least one hinge, and wherein the plurality of light sources are electrically coupled to the power source via at least one wire that runs through a length of the at least one hinge.

8. A housing for charging a plurality of mobile electronic devices comprising:
a body, the body having an top opening, a base, and at least one side wall all defining a cavity therebetween;
a lid pivotably coupled to the body, the lid movable from a closed state covering the top opening to an open state;
a plurality of receptacles disposed within the base for connection of the plurality of mobile electronic devices; and
a power source electrically coupled to the plurality of receptacles to provide electrical power thereto.

9. The housing according to claim 8, further comprising a plurality of stands for supporting the mobile electronic devices.

10. The housing according to claim 9, wherein the housing includes an equal number of the stands and the receptacles.

11. The housing according to claim 9, wherein the plurality of stands are disposed within the cavity of the body.

12. The housing according to claim 11, wherein the plurality of stands are coupled to the base and extend toward the top opening of the body.

13. The housing according to claim 8, wherein the plurality of receptacles include universal serial bus connectors.

14. The housing according to claim 8, wherein the body is generally rectangular shaped, wherein the at least one side wall is a first side, wherein the body further has a front, a back, and a second side.

15. The housing according to claim 8, further comprising a switch, wherein the plurality of receptacles are selectively coupled to the power source via the switch.

16. The housing according to claim 8, further comprising a plurality of light sources electrically coupled to the power source and disposed within the lid.

17. The housing according to claim 16, further comprising a switch, wherein the plurality of receptacles and the plurality of light sources are selectively coupled to the power source via the switch.

18. The housing according to claim 16, further comprising a first switch and a second switch, wherein the plurality of light sources are selectively coupled to the power source via the first switch, wherein the plurality of receptacles are selectively coupled to the power source via the second switch.

19. A housing comprising:
a body, the body having a top opening, a base, and at least one side wall all defining a cavity therebetween;
a lid pivotably coupled to the body, the lid movable from a closed state covering the top opening to an open state, the lid including a translucent screen positioned on an underside of the lid;
a plurality of light sources disposed within the lid;
a plurality of receptacles disposed within the base for connection of mobile electronic devices; and
a power source electrically coupled to the plurality of light sources and the plurality of receptacles to provide electrical power thereto.

20. The housing according to claim 19, wherein the lid further includes a top side opposite the underside, wherein the plurality of light sources are positioned between the underside and the top side.
